(19) United States
(12) Patent Application Publication
(10) Pub. No.: US 2003/0160097 A1
(43) Pub. Date: Aug. 28, 2003

(54) Package and method for merchandise return via mail

(76) Inventor: Gerald Steiner, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/090,120

(22) Filed: Feb. 28, 2002

(51) Int. Cl. G06F 17/60

(52) U.S. Cl. 235/385

(57) ABSTRACT

A package for returning merchandise through the mail is provided. The package preferably includes the merchant's address pre-printed on an outside-facing panel of the package to reduce the likelihood of the package getting lost in the mail. The package may also include return postage. The package includes a bar code that identifies the customer and contains his or her order history. A method of using the bar code to track the customer's order and return history is also provided. A method of using the bar code to provide targeted advertising to the customer is also provided. When a customer places a new order, his or her bar code is scanned, and the information contained therein used to predict what type of advertisements the customer will be interested in. Those types of advertisements are then provided to the customer.

### BACKGROUND OF THE INVENTION

1. Field of the Invention

The present invention relates to packaging for shipping merchandise through the mail, and to methods for using the packaging for inventory control and targeted advertising. More particularly, the present package provides a secure container that includes bar coded information about the customer and his or her order history.

2. Description of the Related Art

Retail consumers often purchase items from printed catalogs or the Internet. Upon receiving and processing an order, the merchant ships the order to the customer through the mail. Some merchants offer exchange programs whereby customers may return previously ordered items and receive in return new or different items. For example, certain video retailers offer purchase plans wherein customers may purchase certain titles, and then return the video discs or video tapes in exchange for new titles.

When returning items through the mail, customers are often careless and do not properly address the return package. Many of these returned items never reach the merchant. Also, when returning large or odd-sized items, purchasers are often annoyed at having to make a special trip to the post office to have the package weighed so that the proper postage can be applied. Consequently, these customers often simply guess at what the proper postage might be, and then attach to the package what they think is an adequate number of stamps. Many of these packages also never reach the intended destination because the postage is inadequate.

When returned items fail to reach their intended destination, some merchants refuse to issue a refund or send the customer a replacement item. When merchants refuse to honor their guarantees, customers feel cheated. Other merchants offer a refund or a replacement item even when they do not receive the returned item. When merchants are this accommodating, customers are satisfied, but the merchant's profit margins suffer because the cost of the refund or replacement item is not offset by the value of the returned item. To offset this decrease in profit margins, merchants often pass along the costs of failed returns to the customers by raising prices.

Thus, packaging that is specially designed to ensure reliable merchandise return would be a benefit to both merchants and customers.

For merchants who offer mail order purchase plans, inventory control is important. As new orders are received, a merchant checks his or her inventory. If the item is in stock, the merchant can ship it right away and the customer will be satisfied. The satisfied customer will likely return to the same merchant in the future. If, however, the item is not in stock, the merchant so informs the customer. The customer can then wait for the item to be available, select an alternate item, or try to get the same item from a different merchant. No matter which option the customer chooses, however, he or she will likely be disappointed with the merchant, and the merchant's rate of repeat business will likely suffer.

Sometimes requested items have been received by the merchant so recently that the items have not yet been entered into the merchant's inventory database. Thus, the merchant tells customers inquiring about these items that the items are not available. In fact the merchant has the items, but he or she is unaware of it. Ideally, merchants would like to minimize these situations and the attendant customer disappointment and loss of future business. Therefore, merchants would like to reduce the lag time between the moment that items are received by the merchant and the moment that the items are entered into the merchant's inventory database.

Therefore, a new method of tracking inventory that allows returned items to be added to the inventory database almost instantaneously would be a benefit to both merchants and customers.

Targeted advertising is an effective method for generating business. Generally, when a person sees an advertisement that pertains to a product or service that is not of interest to him or her, the person simply ignores the advertisement without reading it. Thus, advertisements that reach uninterested consumers represent wasted resources for the advertiser. If a supplier of particular goods and services can identify customers that are interested in purchasing that type of goods and services, the supplier can target his or her advertising toward these customers. The supplier thus spends less money on advertising and still generates a lot of business, because his or her advertising reaches a higher percentage of people who are actually interested in the goods or services contained within the advertising.

Many mail order merchants use targeted advertising. When a merchant who uses targeted advertising ships an order, he or she includes in the package some advertising that is related to the items ordered. Some merchants go one step further and keep a record of all purchases made by particular customers. Then, when the merchant receives a new order from a repeat customer, he or she can scan the customer's purchase history and use the information to decide what advertising should be directed toward that customer.

Unfortunately, the processes that mail order merchants use to identify repeat customers are quite cumbersome. Merchants generally try to identify repeat customers using the customer's name and/or address. However, sloppy handwriting often makes customers' names and addresses hard to read. Thus, employees processing new orders must struggle to match names and addresses with existing customers in a database. This matching is especially difficult when names and addresses must exactly match entries in the database before the database will identify a match. Employees are forced to try alternate spellings and other tricks to identify a match. However, training an employee to successfully use these matching techniques requires an investment of time and money on the part of the merchant. Furthermore, many of these employees are paid low wages and receive no direct benefit from the success of their employer. Thus, they have little incentive to try very hard when their employer is the only person who will directly benefit from their hard work. When employees fail to match new orders with existing customers, the merchant loses opportunities for efficient targeted advertising.

Therefore, a new method of processing orders that facilitates quick and efficient matching of new orders to existing customers would be a benefit to merchants and customers.

### SUMMARY OF THE INVENTION

The preferred embodiments of the package and method for merchandise return via mail have several features, no single one of which is solely responsible for their desirable attributes. Without limiting the scope of this package and method as expressed by the claims that follow, its more prominent features will now be discussed briefly. After considering this discussion, and particularly after reading the section entitled “Detailed Description of the Preferred Embodiments,” one will understand how the features of the preferred embodiments provide advantages, which include decreased likelihood of returned items being lost in the mail, increased ability of merchants to track customer order and return habits, and increased ability of merchants to provide customers with advertising that is of interest to them.

A preferred embodiment of the package for mailing items from a merchant to a customer comprises a bar code that identifies the customer. Preferably, the barcode includes a complete order and return history for the customer. Thus, scanning the barcode preferably enables the merchant to identify items or categories of items in which the customer is interested. Preferably, the package is adapted to be returned from the customer to the merchant via mail.

A preferred embodiment of the method of tracking an order and return history of a customer comprises the step of providing a package including a bar code that identifies the customer. When a merchant receives the package from the customer, the package contains returned items. Preferably, the merchant scans the bar code to identify the customer, inputs the returned items into inventory, and updates the customer's order and return history. In another preferred embodiment, the steps of inputting the returned items into inventory and updating the customer's order and return history are performed simultaneously.

A preferred embodiment of the method of targeted advertising comprises the steps of accumulating information about orders placed by a customer, analyzing the information, and predicting, based on the information, what type of items the customer is likely to purchase in the future. Preferably, a merchant then provides the customer with advertising directed toward the items. This method may further comprise the step of providing a package including a bar code that identifies the customer. This method may further comprise the step of receiving an order from the customer. Finally, this method may further comprise the step of scanning the customer's barcode.

Another preferred embodiment of the method of targeted advertising comprises the steps of accumulating information about orders placed by a customer, analyzing the information, and predicting, based on the information, what type of items the customer is likely to purchase in the future. A merchant then provides the customer with advertising directed toward the items. Preferably, the advertising is provided to the customer in a second package that includes the customer's bar code. This method may further comprise the step of sending the second package to the customer.

### BRIEF DESCRIPTION OF THE DRAWINGS

The preferred embodiments of the package and method for merchandise return via mail, illustrating its features, will now be discussed in detail. These embodiments depict the novel and non-obvious package and method shown in the accompanying drawings, which are for illustrative purposes only. These drawings include the following figures, in which like numerals indicate like parts:

FIG. 1 is a perspective view of a preferred embodiment of the package for return mailing according to the present invention, illustrating the package in a configuration for mailing from merchant to customer;

FIG. 2 is a perspective view of the package of FIG. 1, illustrating the package in an unfolded configuration;

FIG. 3 is a perspective view of the package of FIG. 1, illustrating the package having two panels folded, in an intermediate stage of folding for mailing from merchant to customer;

FIG. 4 is a perspective view of the package of FIG. 1, illustrating the package having three panels folded, in an intermediate stage of folding for mailing from merchant to customer; and

FIG. 5 is a flow chart, illustrating a preferred embodiment of the method according to the present invention for merchandise return via mail using the package of FIG. 1.

### DETAILED DESCRIPTION OF THE PREFERRED EMBODIMENTS

Preferred embodiments of the package comprise a sealable container for two-way shipping of merchandise via mail. Preferably, the package is adapted to be sent by a merchant to a customer, and then to be reused by the customer to return items to the merchant. Further, the package preferably also includes information identifying the customer and his or her order and return history. This information is preferably readily scannable so that the merchant can quickly match the contents of each package to the customer who sent it and update that customer's order history with information about the return.

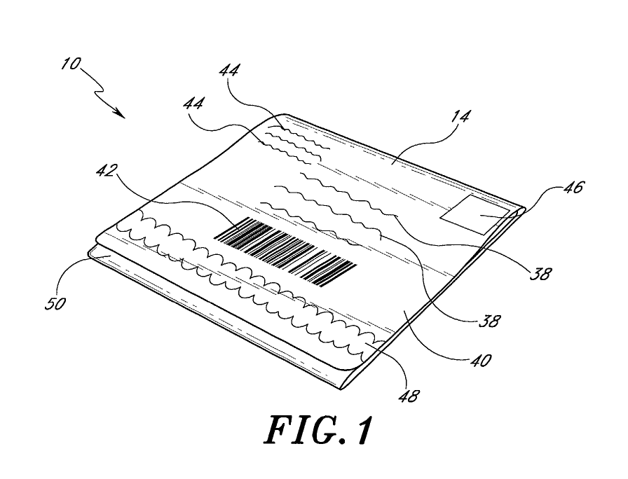

FIGS. 1-4 depict a preferred embodiment of the package 10. The pictured embodiment is adapted for mailing one or more flat items 11, such as compact discs (CD's) and digital versatile discs (DVD's). Those of skill in the art will appreciate, however, that the package 10 may be any size and shape, and may be adapted for containing virtually any item. For example, the package 10 may have a greater height, thereby resembling a box, rather than an envelope. The pictured embodiment is merely illustrative, and should not be interpreted as limiting the package 10 to the size and shape shown.

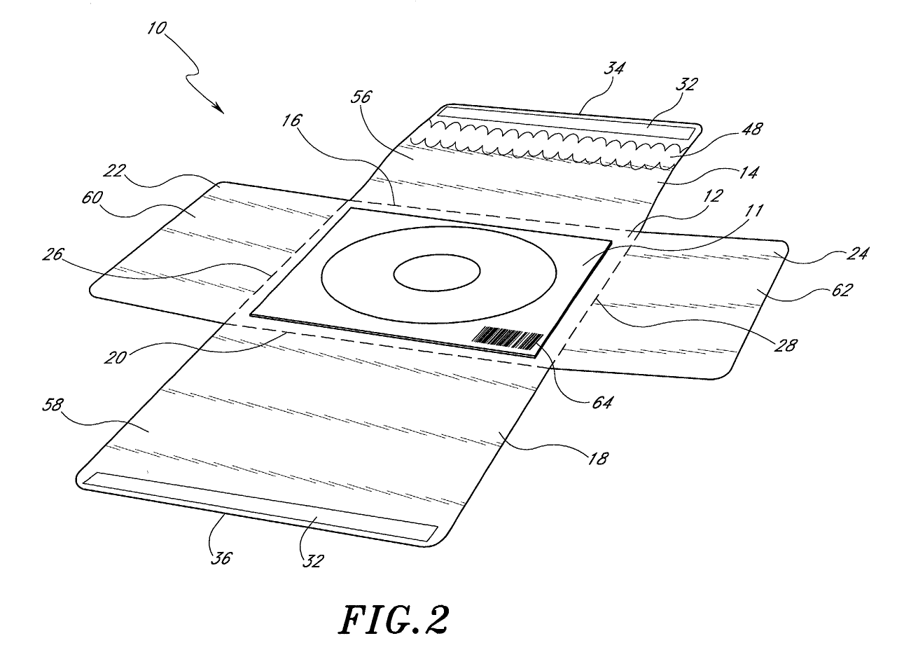

As best seen in FIGS. 1 and 2, the pictured embodiment of the package 10 A comprises a flat sheet including a plurality of panels that are foldable to form a substantially square envelope that is closed on all sides (FIG. 1). The panels may be any size and shape. The package 10 is preferably constructed of a material that is lightweight, but sturdy enough to withstand the ordinary wear and tear associated with two trips through the mail. A preferred material is laminated paperboard.

The embodiment depicted in FIG. 2 includes a central panel 12 that is substantially square. A first panel 14 extends from a top edge 16 of the central panel 12. A second panel 18, substantially equal in size and shape to the first panel 14, extends from a lower edge 20 of the central panel 12. In the pictured embodiment, the first and second panels 14, 18 are substantially rectangular. Third and fourth panels 22, 24, also substantially rectangular, extend from side edges 26, 28 of the central panel 12. Those of skill in the art will appreciate that the shape of each panel need not be rectangular. For example, the central panel 12 may be hexagonal, and include hexagonal panels extending from top and bottom edges and triangular panels extending from the remaining edges. Generally, one panel extends from each edge of the central panel 12. However, more or less panels could extend from one or more edges of the package 10. For example, in a configuration having a square central panel 12, one panel may extend from each of the top and bottom edges 16, 20 and two panels may extend from each of the side edges 26, 28.

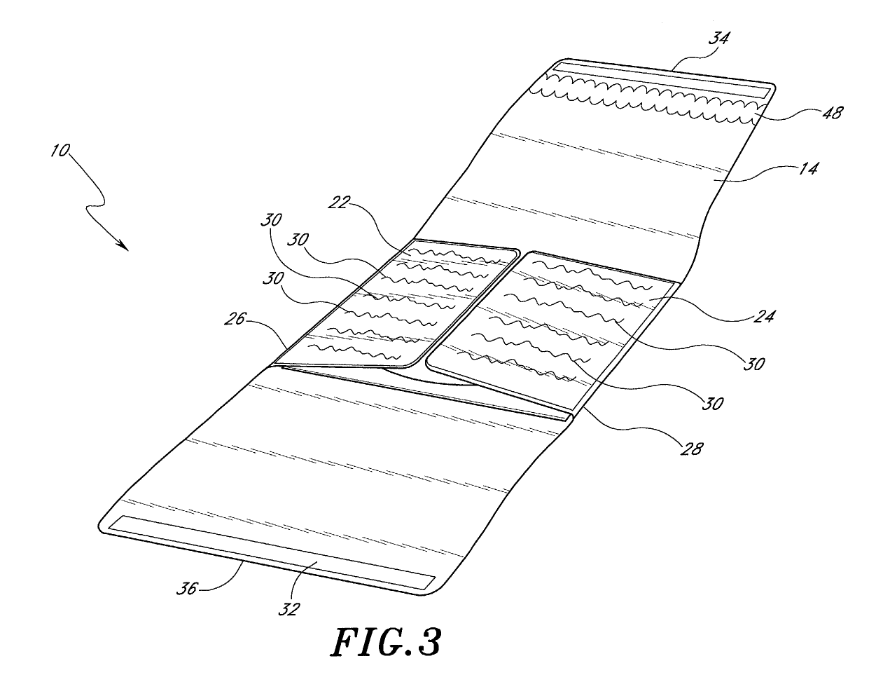

As shown in FIG. 3, each of the third and fourth panels 22, 24 are preferably foldable along the side edges 26, 28 of the central panel 12 to overlap the central panel 12. Each of the third and fourth panels 22, 24 is preferably sized to have an area approximately equal to half the area of the central panel 12. When folded over the central panel 12, each of the third and fourth panels 22, 24 preferably covers one half the area of the central panel 12, and reaches from the top edge 16 to the bottom edge 20 of the central panel 12. One or both of the third and fourth panels 22, 24 may, but need not, include printed text 30 on a surface that faces away from the central panel 12 when the third and fourth panels 22, 24 are folded as shown in FIG. 3. This text may include advertising, instructions on how to properly use the package 10, or any other suitable text. The text 30 may be applied to the package 10 in any appropriate way. For example, the text 30 may be printed directly on the package 10, or may be printed on an adhesive label which is subsequently attached to the package 10.

As shown in FIG. 2, the first and second panels 14, 18 are each preferably substantially equal in size and shape to the central panel 12. The first panel 14 preferably includes an adhesive strip 32 near an edge 34 opposite the central panel top edge 16. The second panel 18 preferably includes an adhesive strip 32 near an edge 36 opposite the central panel bottom edge 20. The first and second panels 14, 18 are preferably foldable along the top and bottom edges 16, 20, respectively, of the central panel 12 to overlap the central panel 12 as shown in FIG. 1. The adhesive strips 32 are preferably on a surface of each panel 14, 18 that faces the central panel 12 when the first and second panels 14, 18 are folded as in FIG. 1. By removing a protective backing from the adhesive strip 32 on the first panel 14, that panel 14 adheres to the second panel 18, forming the sealed package 10. Of course, if the first panel 14 is folded first, and the second panel 18 folded over the top of the first panel 14, then the adhesive strip 32 on the second panel 18 can be adhered to the first panel 14.

Those of skill in the art will appreciate that the panels 14, 18, 22, 24 could be oriented differently. For example, the third and fourth panels 22, 24 may extend from the top and bottom edges 16, 20, respectively, of the central panel 12, and the first and second panels 14, 18 may extend from the side edges 26, 28 of the central panel 12.

As shown in FIG. 1, the first panel 14 preferably includes the customer's name and address 38. The name and address 38 appears on a surface 40 of the first panel 14 that faces outward when the first panel 14 is folded over the central panel 12 as shown in FIG. 1. The customer's address 38 preferably appears near a center of the surface 40. The surface 40 of the first panel 14 also includes a bar code 42 that uniquely identifies the customer. Those of skill in the art will appreciate that the bar code 42 may be located wherever on the package 10 is most convenient, as determined by each merchant individually. In fact, the bar code 42 need not be located on the first panel 14, but may be located anywhere on the package 10. For example, a merchant may wish to place the bar code 42 on an inside surface of the central panel 12 in order to protect the bar code 42 from being damaged as the package 10 travels through the mail.

The first panel 14 may also include the return address 44 of the merchant in an upper left-hand corner, and proper return postage 46 in an upper right-hand corner, as shown in FIG. 1. The placement of addresses 38, 44 and postage 46 on the package 10 is, as described, preferably according to U.S. Postal Service guidelines. However, the addresses 38, 44 and postage 46 could be placed anywhere on the package 10. In addition, the addresses 38, 44 may be affixed in any appropriate way, such as by the methods described above with respect to the text 30 on the third and fourth panels 22, 24.

The first panel 14 preferably includes a tear-away strip 48 adjacent the edge 34 opposite the central panel top edge 16. The strip 48 is preferably located between the central panel 12 and the adhesive strip 32 on the first panel 14. Thus, when the adhesive strip 32 is secured to the panel 18 or panels 22, 24 beneath, removing the tear-away strip 48 releases the first panel 14 from the second panel 18 or third and fourth panels 22, 24. Once the first panel 14 is unfolded, the remaining panels 18, 22, 24 are unfolded to expose the contents of the package 10.

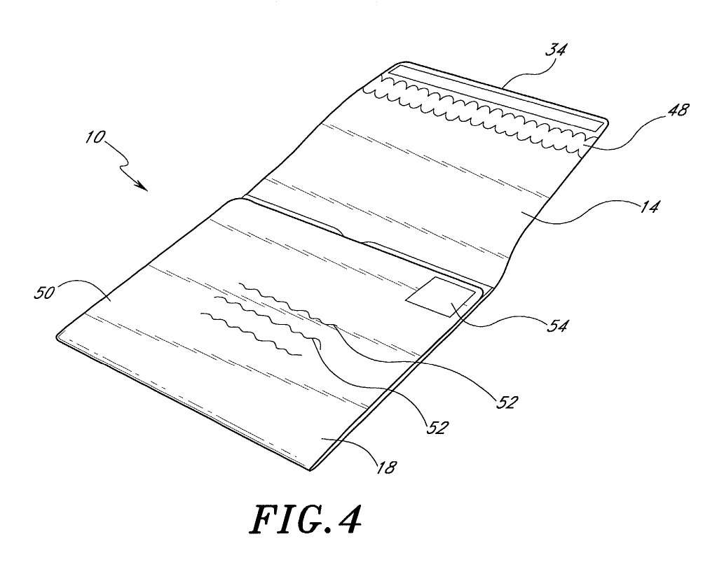

In order to encourage customers to use the package 10 to return items, an outer surface 50 of the second panel 18 preferably includes the merchant's address 52, as shown in FIG. 4. Again, according to postal guidelines, the merchant's address 52 preferably appears near a center of the outer surface 50. The second panel 18 may also include postage 54 in an upper right-hand corner.

### METHOD OF USE

When a merchant mails an item to a customer using the package 10, he or she inserts the item 11 into the flat, unfolded package 10, as depicted in FIG. 2. Before placing the item 11 in the package 10, the merchant applies the customer's address 38 and the merchant's return address 44 to the first panel 14 (FIG. 1), and applies the merchant's return address 52 to the second panel 18 (FIG. 4) in the manner described above. The merchant may also apply postage 46, 54 to the first panel 14 and/or second panel 18 at this time in the manner described above. Alternatively, the merchant may apply addresses and postage after placing the item 11 in the package 10. Each merchant determines the easiest and most efficient order for the packaging steps individually.

According to one preferred method of using the package 10, after the merchant positions an item 11 on the center panel as in FIG. 2, the merchant folds the third and fourth panels 22, 24 over the item 11 (FIG. 3). Next, the merchant folds the second panel 18 over the third and fourth panels 22, 24 (FIG. 4). The adhesive strip 32 on the second panel 18 preferably remains covered by a protective backing at this time so that the second panel 18 does not stick to the third and fourth panels 22, 24. Finally, the merchant folds the first panel 14 over the second panel 18 and secures the adhesive strip 32 on the first panel 14 to the outside surface 50 of the second panel 18 to seal the package 10 (FIG. 1). With proper addressing and postage applied, the package 10 is ready to be mailed.

According to another preferred embodiment, the folding proceeds as just described, except that the merchant folds the second panel 18 first, followed by the third and fourth panels 22, 24, and finally the first panel 14. In this order of folding, the merchant secures the adhesive strip 32 on the first panel 14 directly to the third and fourth panels 22, 24.

Those of skill in the art will appreciate that the merchant may apply the customer's address 38 to the second panel 18, and the merchant's address 52 to the first panel 14. In any case, preferably the merchant folds the panel including the customer's address 38 last when sealing the package 10 for delivery to the customer.

Upon receiving the package 10, the recipient preferably opens it by removing the tear-away strip 48 on the first panel 14 and unfolding the package 10 as described above. If the recipient wishes to return the item 11 for any reason, he preferably replaces it in the package 10 and folds the panels around it. When using the package 10 to return an item 11, however, the customer preferably folds the panels 14, 18, 22, 24 in a different order from that outlined above.

First, the customer folds the third and fourth panels 22, 24 as above. Next, however the customer folds the first panel 14, followed by the second panel 18. The customer secures the adhesive strip 32 on the second panel 18 to the outside surface 40 of the first panel 14 to seal the package 10. When the panels are folded in this order, the customer's address 38 is covered by the second panel 18. Preferably, the second panel 18 is pre-printed with the merchant's address 52, and the second panel 18 also includes proper postage 54 or a label that indicates that postage will be paid by the merchant subsequent to delivery. However, the second panel 18 may also be blank, in which case the customer may type or hand-write the merchant's address and apply postage before mailing the package 10. If the merchant pre applies his or her address to the package 10, there is very little chance that the package 10 will be misdirected. And if the merchant pre-applies the proper amount of postage or a label indicating that the merchant will pay the postage, there is even less chance that the package 10 will fail to reach the merchant, because the customer will be relieved of the responsibility to apply the proper postage.

As described above, the third and fourth panels 22, 24 preferably include text 30, although they need not include any text 30 at all. To encourage customers to use the package 10 to return items, the text 30 may comprise printed instructions on how to reuse the package 10 for return to the merchant. Such instructions are, of course, not necessary, but may be very helpful when the package 10 is sent to a first time customer. Such first time customers may not be familiar with the advantages of using the package 10 to return items. Thus, without informative instructions these customers may discard the package 10 before returning items. Rather than printing instructions directly on the panels 22, 24, the merchant may instead insert an instruction sheet into the package 10 prior to sealing and mailing the package 10. Further, those of skill in the art will appreciate that the text 30, and any other text or printing of any kind may be positioned anywhere on the package 10, including, for example, inner surfaces 56, 58, 60, 62, respectively, of the panels 14, 18, 22, 24 (FIG. 2).

The panels 14, 18, 22, 24 may also be printed with advertising, for example. Rather than printing advertisements directly on the panels 14, 18, 22, 24, the merchant may instead insert one or more advertisements as separate sheets into the package 10 prior to sealing and mailing the package 10.

When sending items to repeat customers, the advertising may be tailored to provide information about products and services that those particular customers have purchased before. When a customer places orders with a merchant, the merchant keeps track of the items that the customer orders. By reviewing the customer's order history, the merchant better understands what types of items the customer is interested in. The merchant then predicts what types of items the customer is interested in buying in the future. Using these predictions as a guideline, the merchant provides the customer with advertising for those types of items. Such targeted advertising increases the merchant's profitability by increasing sales without appreciably increasing advertising costs.

Targeted advertising is especially effective at generating repeat business in movie exchange programs, for example. In these programs, a customer typically purchases movies on DVD or VHS, for example, from a merchant. After viewing each movie, the customer has the option to keep the movie as part of his or her permanent collection, or return the movie to the merchant in exchange for a different title. By viewing each customer's purchase and return history, the merchant can determine what types of movies each customer is likely to enjoy. For example, if Customer A has purchased many action/adventure titles and many comedy titles, but has consistently kept the action/adventure titles and returned the comedy titles, it is likely that Customer A would be most interested in advertising about action/adventure movies. To increase sales, then, the merchant inserts advertisements regarding action adventure movies into Customer A's future orders.

When the merchant receives returned items 11, he or she opens the package 10 and removes the items 11. The merchant then scans the bar code 42 on the package 10 to identify the customer making the return. The merchant then inputs the returned items 11 into an inventory database. The merchant may input the items manually such as by typing a name or identifying code for the item.

Alternatively, the input process may be more automated. For example, each item 11 may include its own bar code 64 (FIG. 2). By scanning the bar code 64 on each item, the merchant almost instantaneously updates his or her inventory database in a virtually error free way. The items 11 returned are thus quickly made available to be sold to other customers. This return method decreases the lag time between when each item 11 is returned and when it is available for sale. The reduced lag time reduces the merchant's lost sales that result from the merchant's ignorance of recently returned items.

Alternatively, scanning the bar code 42 on the package 10 may call up a list of all items that that customer has previously ordered. The list may be organized chronologically, alphabetically, or any other appropriate way. Each item may also have a unique number associated with it, such as a position in the list. The merchant can then select items from the list that are contained in the returned package 10 in order to return those items to the inventory database. Selecting items from the list may involve typing the unique numbers associated with each item, clicking on entries in the list, etc.

By scanning the bar code 42 on the package 10 before entering the returned items 11 into the inventory database, the merchant not only updates his or her inventory database, but also updates the return history of that customer. This valuable information is then available for the merchant to use in the future, for example, when deciding what sort of advertising to direct toward that customer.

### EXAMPLE

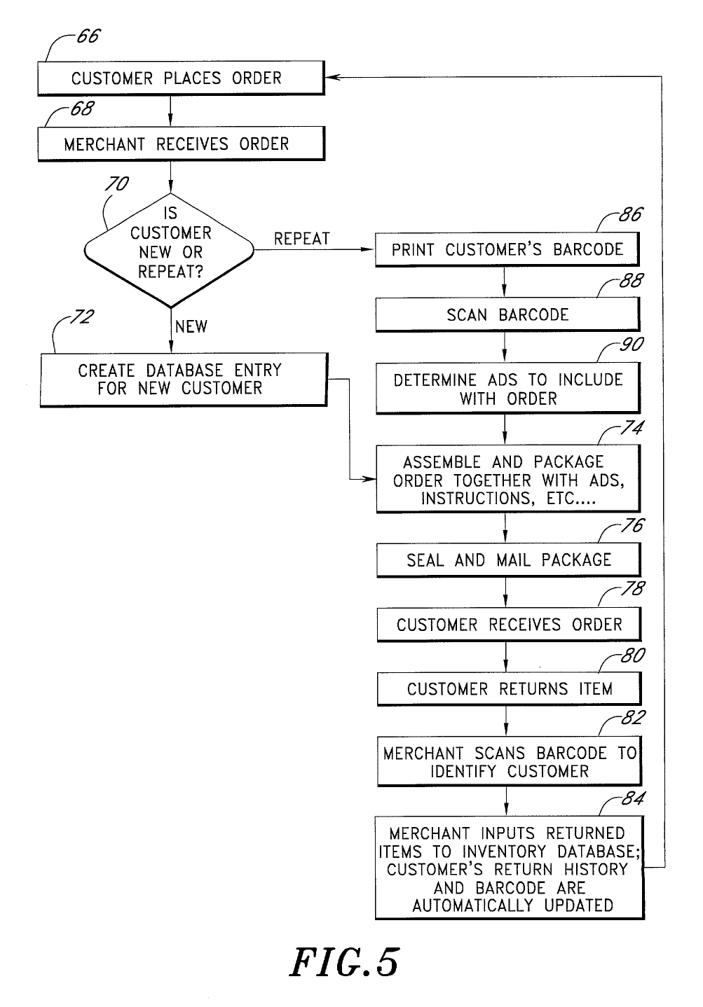

The advantages of the present package 10 and method for merchandise return via mail are apparent in the following example of a typical order and return cycle. The steps of the cycle are illustrated in FIG. 5. For convenience, the example refers to a DVD exchange program of the type identified above. Those of skill in the art will appreciate, however, that the present package 10 and method are useful for ordering and returning virtually any type of item.

First, a customer places an order 66. The order may be placed over the Internet, over the telephone, or through the mail, for example. When the merchant receives the order 68, the merchant identifies whether the customer is a first time or repeat customer 70. If the customer is new, the merchant enters the customer's information into the customer database 72. The merchant then assembles the new customer's order 74, seals in the package in the manner described above, and mails the package to the new customer 76. The merchant may include advertisements in the new customer's order 74.

When the new customer receives his or her order 78, he or she opens the package in the manner described above and views the DVD's. After viewing, the new customer decides whether to keep or return some or all of the DVD's. The merchant may establish a time limit after which a customer can no longer return an order, or the merchant may offer an unlimited return policy. If and when the new customer decides to return some or all of the DVD'S, he or she seals them in the package as described above and sends them back to the merchant 80.

When the merchant receives the returned package, the merchant scans the bar code 42 (FIG. 1) to identify the customer 82. The merchant then inputs the returned DVD's into the inventory database 84 using one of the methods described above, or another suitable method. The bar code scanning step 82 allows the input step 84 to automatically update the customer's order and return history to include the titles that the customer returned in this package. Preferably the bar code scanning step 82 also allows the input step 84 to automatically update the customer's bar code. The cycle begins again when the customer places another order 66.

When a repeat customer places an order, the merchant prints that customer's bar code 86. The information contained within the bar code preferably includes the customer's identifying information and his or her entire history of orders and returns, including the most recent returns. Upon scanning the bar code 88, the merchant quickly determines what types of movies the repeat customer likes, and decides what advertisements to include in that customer's order 90.

In a preferred embodiment, a computer algorithm performs the process of determining the customer's likes and dislikes, and of selecting advertisements for that customer 90. For example, the algorithm may return general information such as categories of movies that the customer likes, such as comedies and westerns. The merchant then selects advertisements pertaining to comedies and westerns and includes them in the customer's order. Alternatively, the algorithm may return more specific information, such as specific advertisements that that customer should receive. The advertisements may be separate pieces of paper or the like, or may be printed directly on the package 10.

Of course, the merchant could instead perform the function of the computer algorithm himself or herself. For example, when the merchant scans the bar code, the repeat customer's order and return history may appear on a computer screen. The merchant can then analyze the information and look for patterns. Each customer's pattern of movie viewing behavior, especially with regard to movies retained by the customer, indicates what types of movies he or she likes. By selecting advertisements that focus on these types of movies, the merchant increases the likelihood that each customer will respond positively to the advertisements, and thereby increases his or her sales and profitability.

Targeted advertising further increases the merchant's profitability by increasing the premium that the merchant may charge third party advertisers for having their advertisements included in packages that the merchant sends to his or her customers. The cost of advertising through a particular medium, such as through inserts in packages mailed to retail customers, is directly related to the likelihood that that advertising will generate sales. With targeted advertising, that likelihood of sales generation is relatively high. Therefore, merchants using targeted advertising can charge third party advertisers higher premiums than the premiums charged by merchants who do not use targeted advertising.

### Scope of the Invention

The above presents a description of the best mode contemplated for the present package and method for merchandise return via mail, and of the manner and process of making and using it, in such full, clear, concise, and exact terms as to enable any person skilled in the art to which it pertains to make and use this package and method. This package and method are, however, susceptible to modifications and alternate constructions from that discussed above which are fully equivalent. Consequently, it is not the intention to limit this package and method to the particular embodiments disclosed. On the contrary, the intention is to cover all modifications and alternate constructions coming within the spirit and scope of the package and method as generally expressed by the following claims, which particularly point out and distinctly claim the subject matter of the package and method.

What is claimed is:

1. A package for mailing items from a merchant to a customer, the package comprising:
at least one surface, the surface having a bar code thereon; wherein
the bar code identifies the customer.

2. The package of claim 1, wherein the bar code includes a complete order and return history for the customer.

3. The package of claim 1, wherein the package is adapted to be returned from the customer to the merchant via mail.

4. The package of claim 1, wherein scanning the bar code enables the merchant to identify items or categories of items in which the customer is interested.

5. A method of tracking an order and return history of a customer, the method comprising the steps of:
providing a package including a bar code that identifies the customer;
receiving the package from the customer, the package containing returned items;
scanning the bar code to identify the customer;
inputting the returned items into an inventory database; and
updating the customer's order and return history.

6. The method of claim 5, wherein the steps of inputting the returned items into the inventory database and updating the customer's order and return history are performed simultaneously.

7. A method of targeted advertising, the method comprising the steps of:
accumulating information about orders placed by a customer;
analyzing the information;
predicting, based on the information, what type of items the customer is likely to purchase in the future; and
providing the customer with advertising directed toward those items.

8. The method of claim 7, the method further comprising the step of.
providing a package including a bar code that identifies the customer.

9. The method of claim 8, the method further comprising the step of:
receiving an order from the customer.

10. The method of claim 9, the method further comprising the step of:
scanning the customer's bar code.

11. The method of claim 8, wherein the advertising is provided to the customer in a second package that includes the customer's bar code.

12. The method of claim 11, the method further comprising the step of sending the second package to the customer.
